(19) United States
(12) Patent Application Publication
(10) Pub. No.: US 2025/0381658 A1
(43) Pub. Date: Dec. 18, 2025

(54) FOOD PROCESSING APPARATUS

(71) Applicant: Steven NYDELL, Long Beach, CA (US)

(72) Inventor: Steven NYDELL, Long Beach, CA (US)

(21) Appl. No.: 18/740,796

(22) Filed: Jun. 12, 2024

(51) Int. Cl. B25G 3/02; B26B 3/00

(52) U.S. Cl. CPC B25G 3/02; B26B 3/00

(57) ABSTRACT

A food processing apparatus comprising a first blade component having a proximal end and a distal end; a handle comprises a tang, a bolster, and a butt, wherein the handle is coupled to the first blade component by the proximal end of the first blade component through the bolster.

### BACKGROUND

### Field

The present disclosure is generally directed to a food processing apparatus, in particular, an apparatus for food cutting and stripping.

### Related Art

Food preparation often involves cutting, stripping, and slicing food items such as vegetables, fruits, etc., for further processing and presentation. In the related art, a conventional knife is disclosed. While a knife may be used in cutting and slicing food items, the process tends to be time consuming and often results in creation slices/strips that are not uniform in shape and thickness. At the same time, it takes years of practice before one can achieve such level of mastery using a conventional knife.

In the related art, a conventional food peeler is disclosed. The food peeler is a prominent tool used in food preparation (e.g., slicing, stripping, etc.) However, the conventional food peeler does have a few drawbacks. Specifically, generating food waste through overcutting and creating strips that are not uniform in shape and width. This often led to repeated use of the peeler to create strips that need to be further processed (e.g., trimmed through a separate tool such as a knife, etc.) before arriving at a desired state (e.g., garnishes, presentable shapes, etc.).

Accordingly, there is an unmet need for a food processing apparatus that not only allows for ease of use, but minimizes/reduces food waste and creates even and uniform shapes.

### SUMMARY

Aspects of the present disclosure involve an innovative food processing apparatus. The food processing apparatus may include a first blade component having a proximal end and a distal end; and a handle comprises a tang, a bolster, and a butt, wherein the handle is coupled to the first blade component by the proximal end of the first blade component through the bolster.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates a perspective view of an example food processing apparatus 100 in a first position, in accordance with an example embodiment.

FIG. 2 illustrates an assembly diagram 200 of the food processing apparatus 100, in accordance with an example embodiment.

FIG. 3 illustrates a perspective view of the food processing apparatus 100 in a second position, in accordance with an example embodiment.

FIG. 4 illustrates a perspective view of the food processing apparatus 100 in a third position, in accordance with an example embodiment.

FIG. 5 illustrates a side view of the food processing apparatus 100, in accordance with an example embodiment.

FIG. 6 illustrates a side view of the food processing apparatus 100, in accordance with an example embodiment.

FIG. 7 illustrates the food processing apparatus 100 at a first cutting/stripping position in a perspective review.

FIG. 8 illustrates a perspective view of an example food processing apparatus 800 in a first position, in accordance with an example embodiment.

FIG. 9 illustrates an assembly diagram 900 of the food processing apparatus 100, in an example embodiment.

FIG. 10 illustrates a perspective view of the food processing apparatus 800 in a second position, in accordance with an example embodiment.

FIG. 11 illustrates a perspective view of the food processing apparatus 800 in a third position, in accordance with an example embodiment.

FIG. 12 illustrates a side view of the food processing apparatus 800, in accordance with an example embodiment.

FIG. 13 illustrates a side view of the food processing apparatus 800, in accordance with an example embodiment.

FIG. 14 illustrates the food processing apparatus 800 at a first cutting position in a perspective review.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Example implementations as described herein can be utilized either singularly or in combination and the functionality of the example implementations can be implemented through any means according to the desired implementations.

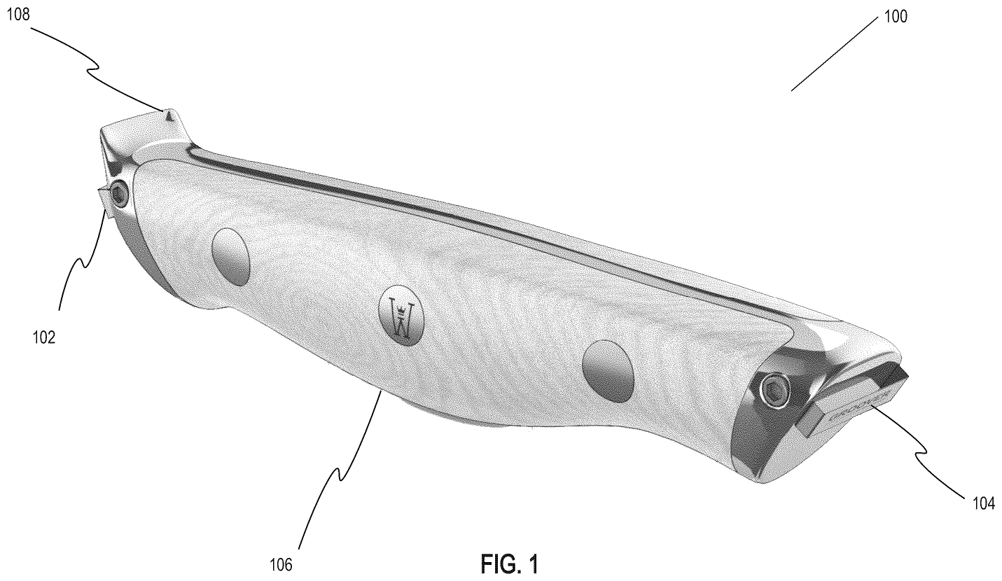

FIG. 1 illustrates a perspective view of an example food processing apparatus 100 in a first position, in accordance with an example embodiment. As illustrated in FIG. 1, the food processing apparatus 100 may include a first blade component 102, a second blade component 104, a handle portion 106, and a blunt component 108. The blunt component 108 will be described in more detail below.

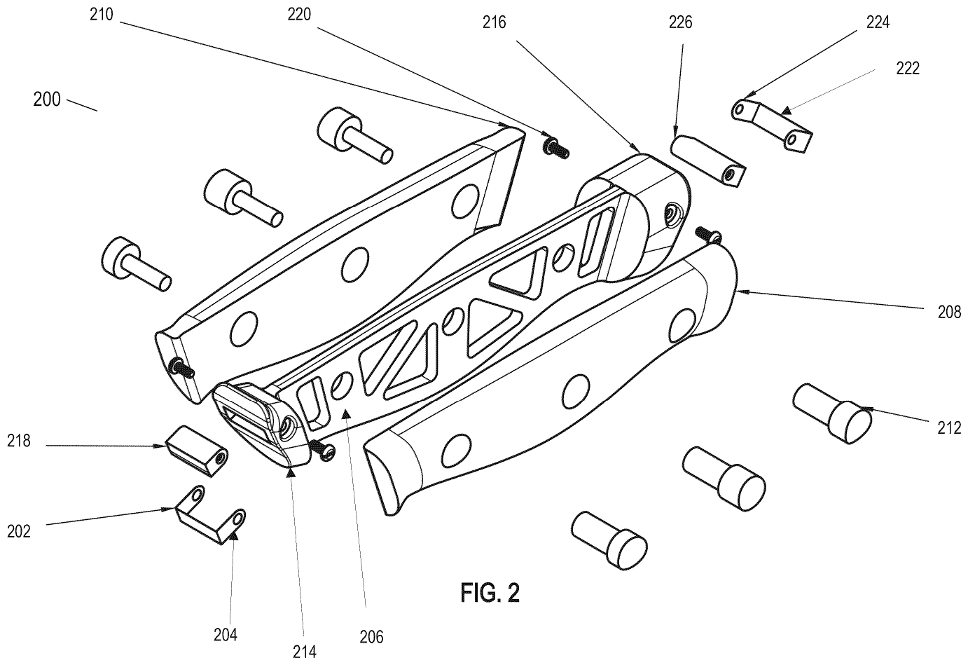

FIG. 2 illustrates an assembly diagram 200 of the food processing apparatus 100, in accordance with an example embodiment. As illustrated in FIG. 2, the first blade component 102 comprises a bladed/cutting side 202 on a distal end of the first blade component 102 and a fastening/securing side 204 at a proximal end of the first blade component 102. The bladed/cutting side 202 is an elongated rectangular strip having a blade edge facing the handle. The fastening/securing side 204 comprises a pair of connectors that are connected or attached to the bladed/cutting side 202. Each connector of the pair of connectors is connected or attached to an end of the bladed/cutting side 202.

The first blade component 102 may be manufactured from materials such as, but not limited to, carbon steel, stainless steel, a laminate of steel materials, ceramic materials (e.g., aluminum oxide (Al₂O₃), zirconium oxide (ZrO₂, etc.), etc. In some embodiments, the bladed/cutting side 202 may have a width between 1 to 3 cm, which allows for consistent and measured stripping/cutting of vegetables and fruits such as citrus. For example, blades of 1.5 cm may be used for smaller citrus fruits (having smaller circular arcs) such as limes and dwarf lemons, blades of 2 cm may be used for larger fruits such as oranges, grapefruits, and yuzus, which have larger circular arcs). The range of 1 to 3 cm is smaller than cutting width of conventional food peelers, and ensures uniformity across the cutting area.

In some embodiments, the first blade component 102 is U-shaped, with the bladed/cutting side 202 being perpendicular to the fastening/securing side 204. In some alternative embodiments, the first blade component 102 is U-shaped, with the bladed/cutting side 202 being substantially perpendicular to the fastening/securing side 204 (e.g., trapezoidal, reverse-trapezoidal, etc.).

The handle portion 106 comprises components that include, but not limited to, a tang 206, a first scale component 208, a second scale component 210, etc. Similar to the first blade component 102, the tang 206 may be manufactured from materials such as, but not limited to, carbon steel, stainless steel, a laminate of steel materials, ceramic materials (e.g., aluminum oxide (Al₂O₃), zirconium oxide (ZrO₂, etc.), etc.

The first scale component 208 and the second scale component 210 are secured against the tang 206 by rivets 212. The first scale component 208 and the second scale component 210 may be formed from materials such as, but not limited to, G10, micarta, plastic, rubber, carbon fiber, wood, resin treated materials, composite materials, organic materials such as bones and horns, etc. In some embodiments, the first scale component 208 may be formed from a material that is different from that of the second scale component 210. For example, wood may used as the first scale component 208, while rubber is used as the second scale component 210.

As illustrated in FIG. 2, the handle portion 106 further includes a bolster 214 and a butt 216. The bolster 214 is located at a first end of the tang 206, while the butt 216 is on a second end of the tang 206. Each of the bolster 214 and the butt 216 has a cavity for inserting a screw receiving component/receiver. To secure the first blade component 102 against the handle portion 106, the screw receiving component/receiver 218 is first inserted into the cavity of the bolster 214. The connectors of the fastening/securing side 204 are then positioned/placed between the screw receiving component/receiver 218 and the bolster 214, and screws 220 may be utilized to secure the first blade component 102 against the bolster 214 through openings located along the connectors and the bolster 214.

The second blade component 104 comprises a bladed/cutting side 222 on a distal end of the second blade component 104 and a fastening/securing side 224 at a proximal end of the second blade component 104. The bladed/cutting side 222 is an elongated rectangular strip having a blade edge facing the handle. The fastening/securing side 224 comprises a pair of connectors that are connected or attached to the bladed/cutting side 222. Each connector of the pair of connectors is connected or attached to an end of the bladed/cutting side 222.

The second blade component 104 may be manufactured from materials such as, but not limited to, carbon steel, stainless steel, a laminate of steel materials, ceramic materials (e.g., aluminum oxide (Al₂O₃), zirconium oxide (ZrO₂, etc.), etc. Embodiments of the food processing apparatus 100 may include a first blade component 102 having a width that differs from a width of the second blade component 104. For example, the first blade component 102 may have a bladed/cutting side 202 with a width of 1.5 cm, and the second blade component 104 may have a bladed/cutting side 222 with a width of 2 cm. This allows for optimal cutting and stripping of food of all sizes or all circular arcs in one single tool.

Similar to the first blade component 102, the second blade component 104 may be U-shaped, with the bladed/cutting side 222 being perpendicular to the fastening/securing side 224. In some alternative embodiments, the second blade component 104 is U-shaped, with the bladed/cutting side 222 being substantially perpendicular to the fastening/securing side 224 (e.g., trapezoidal, reverse-trapezoidal, etc.).

To secure the second blade component 104 against the handle portion 106, the screw receiving component/receiver 226 is first inserted into the cavity of the butt 216. The connectors of the fastening/securing side 224 are then positioned/placed between the screw receiving component/receiver 226 and the butt 216, and screws 220 may be utilized to secure the second blade component 104 against the butt 216 through openings located along the connectors and the butt 216.

In some embodiments, instead of having both the first blade component 102 and the second blade component 104, the food processing apparatus 100 may have only the first blade component 102 or the second blade component 104. In some embodiments, the food processing apparatus 100 may have both the first blade component 102 and the second blade component 104, but not the blunt component 108.

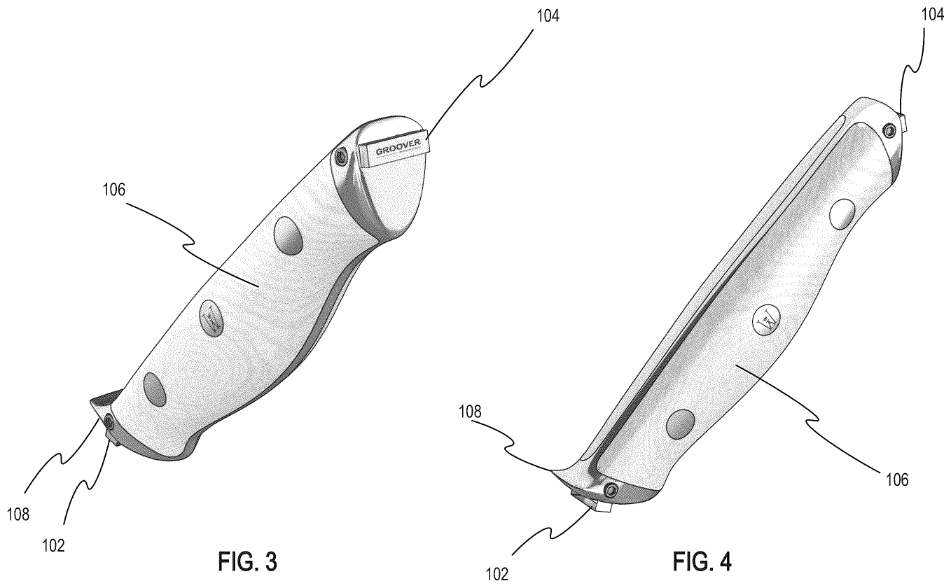

FIG. 3 illustrates a perspective view of the food processing apparatus 100 in a second position, in accordance with an example embodiment. FIG. 4 illustrates a perspective view of the food processing apparatus 100 in a third position, in accordance with an example embodiment.

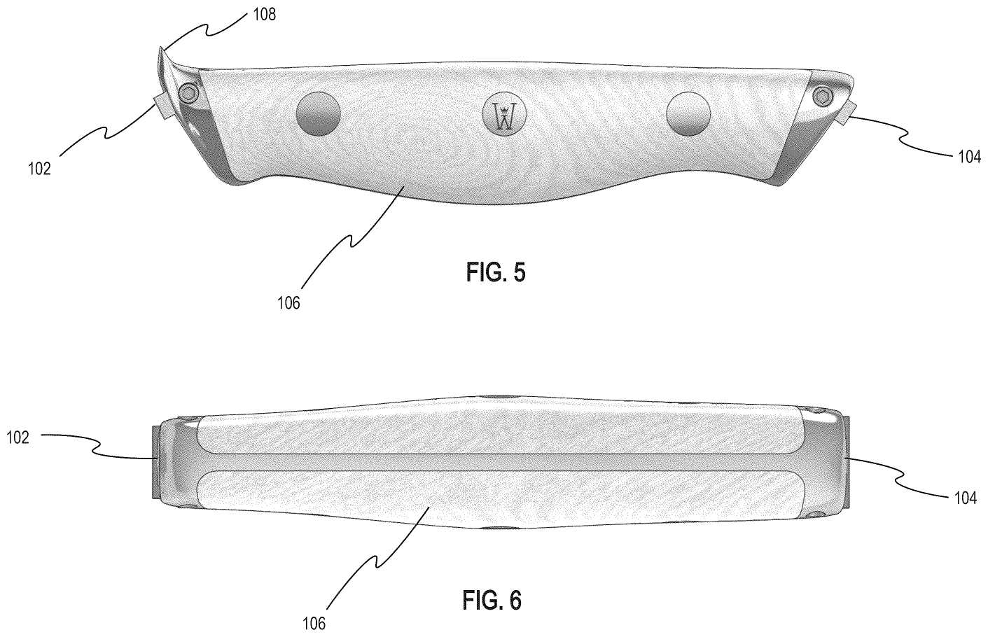

FIG. 5 illustrates a side view of the food processing apparatus 100, in accordance with an example embodiment. FIG. 6 illustrates a side view of the food processing apparatus 100, in accordance with an example embodiment. As illustrated in FIG. 6, the first blade component 102 is smaller in width when compared to the second blade component 104.

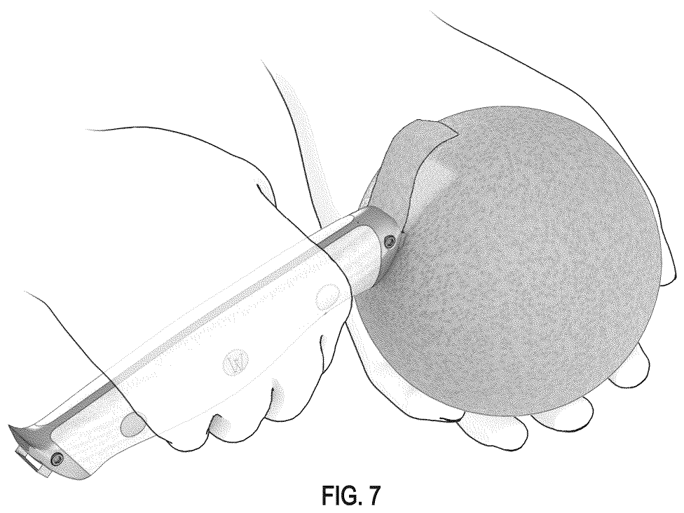

FIG. 7 illustrates the food processing apparatus 100 at a first cutting/stripping position in a perspective review. As illustrated in FIG. 7, an orange is being processed using the food processing apparatus 100. Consistent and clean-cut orange peels/strips can be produced by applying the second blade component 104 directly against the orange and sliding the food processing apparatus 100 along the outer skin of the fruit. Given the second blade component 104 has a width smaller than conventional fruit peeler, this produces peels/strips having clean/even edges that run along the cutting direction. In addition, for creating garnishes from orange peels/strips, use of the food processing apparatus 100 minimizes food waste from uneven overcutting.

While the resulting peels/strips would have clean/even side edges, the beginning and ending (top and bottom) of the peels/strips may appear a little uneven due to angle of the cut and/or the surface of the food/produce. To ensure the peels/strips would have clean/even edges on all four sides, the blunt component 108 (e.g., a blunt dull cutting edge, etc.) may be used to trim the uneven top and bottom edges. Specifically, the food processing apparatus 100 is flipped so that the blunt component 108 is downward facing. By pressing the blunt component 108 directly against the uneven sides/edges of the peels/strips, a straight edge/cut can be formed, resulting in clean/even edges on all sides.

In some embodiments, the depth of the fastening/securing side 204 is the same as the depth of the fastening/securing side 224. In other embodiments, the depth of the fastening/securing side 204 differs from the depth of the fastening/securing side 224. For example, a blade component with a width of 1.5 cm would have a depth shallower/shorter than that of a blade component with a width of 2 cm. Higher/longer depth allows for deeper penetration into the skin of the fruit and is particularly useful when the produce/food has a thick flavedo/zest layer.

In some embodiments, the depth of the blade component may be optimized to process certain food items. Using the orange as an example, the blade component may have an optimized depth to prevent the food processing apparatus 100 from cutting into or too deep into the albedo (mesocarp) of the orange, which has an unpleasant bitter taste.

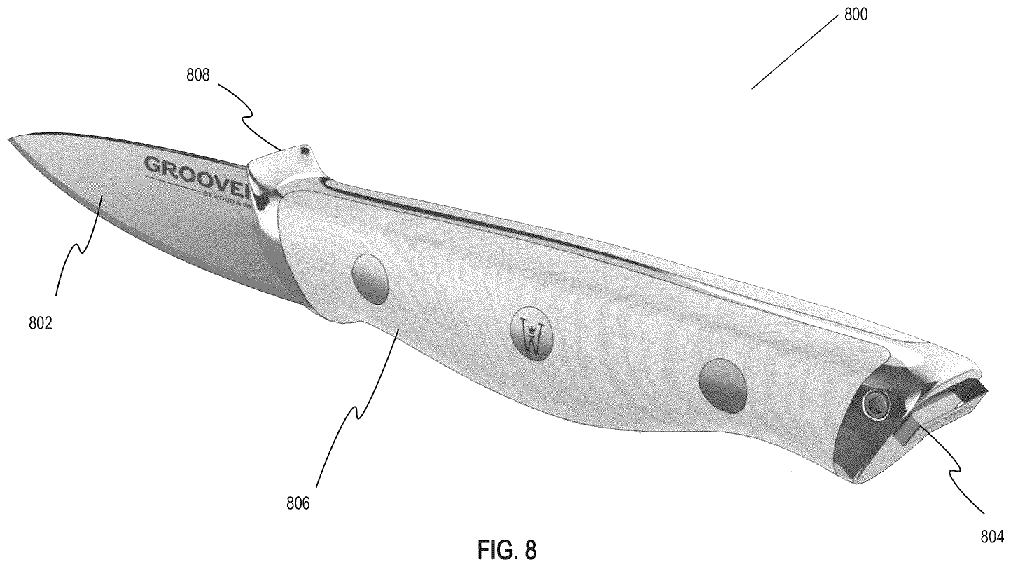

A second embodiment and the use thereof are illustrated in FIGS. 8-14. FIG. 8 illustrates a perspective view of an example food processing apparatus 800 in a first position, in accordance with an example embodiment. As illustrated in FIG. 8, the food processing apparatus 800 may include a first blade component 802, a second blade component 804, a handle portion 806, and a blunt component 808.

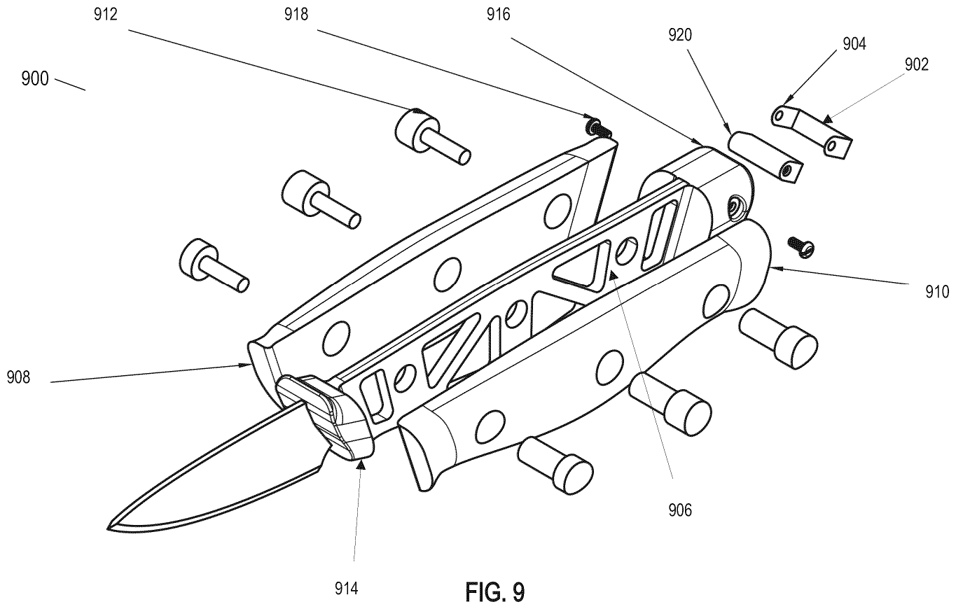

FIG. 9 illustrates an assembly diagram 900 of the food processing apparatus 100, in an example embodiment. As illustrated in FIG. 9, the first blade component 802 comprises a knife blade having a proximal end and a distal end. The proximal end of the knife blade is coupled to the handle portion 806. The distal end of the knife blade comprises a knife point where the cutting edge and the spine of the knife blade meet.

The first scale component 908 and the second scale components 910 are secured against the tang 906 by rivets 912. The first scale component 908 and the second scale component 910 may be formed from materials such as, but not limited to, G10, micarta, plastic, rubber, carbon fiber, wood, resin treated materials, composite materials, organic materials such as bones and horns, etc. In some embodiments, the first scale component 908 may be formed from a material that is different from that of the second scale component 910. For example, wood may used as the first scale component 908, while rubber is used as the second scale component 910.

As illustrated in FIG. 9, the handle portion 806 further includes a bolster 914 and a butt 916. The bolster 914 is located at a first end of the tang 906, while the butt 916 is on a second end of the tang 906. The butt 916 has a cavity for inserting a screw receiving component/receiver 920. To secure the second blade component 804 against the handle portion 806, the screw receiving component/receiver 920 is first inserted into the cavity of the butt 916. The connectors of the fastening/securing side 904 are then positioned/placed between the screw receiving component/receiver 920 and inner side walls that form the cavity in the butt 916, and screws 918 may be utilized to secure the second blade component 804 against the butt 916 through openings located along the connectors and the butt 916.

The handle portion 806 comprises component that include, but not limited to, a tang 906, a first scale component 908, a second scale component 910, etc. The first blade component 802, the tang 906, the bolster 914, and the butt 916 may be manufactured from materials such as, but not limited to, carbon steel, stainless steel, a laminate of steel materials, ceramic materials (e.g., aluminum oxide (Al₂O₃), zirconium oxide (ZrO₂, etc.), etc.

The second blade component 804 comprises a bladed/cutting side 902 on a distal end of the second blade component 804 and a fastening/securing side 904 at a proximal end of the second blade component 804. The bladed/cutting side 902 is an elongated rectangular strip having a blade edge facing the handle. The fastening/securing side 904 comprises a pair of connectors that are connected or attached to the bladed/cutting side 902. Each connector of the pair of connectors is connected or attached to an end of the bladed/cutting side 902.

The second blade component 804 may be manufactured from materials such as, but not limited to, carbon steel, stainless steel, a laminate of steel materials, ceramic materials (e.g., aluminum oxide (Al₂O₃), zirconium oxide (ZrO₂, etc.), etc.

Similar to the first blade component 102, the second blade component 804 may be U-shaped, with the bladed/cutting side 902 being perpendicular to the fastening/securing side 904. In some alternative embodiments, the second blade component 804 is U-shaped, with the bladed/cutting side 902 being substantially perpendicular to the fastening/securing side 904 (e.g., trapezoidal, reverse-trapezoidal, etc.).

To secure the second blade component 804 against the handle portion 806, the screw receiving component/receiver 920 is first inserted into a cavity of the butt 916. The connectors of the fastening/securing side 904 are then positioned/placed between the screw receiving component/receiver 920 and the butt 916, and screws 918 may be utilized to secure the second blade component 804 against the butt 916 through openings located along the connectors and the butt 916.

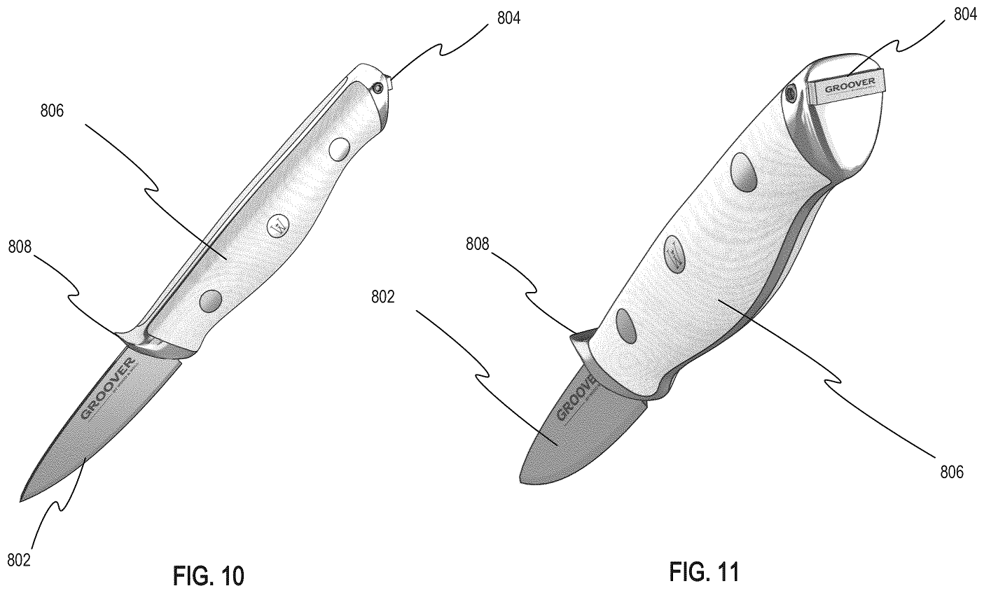

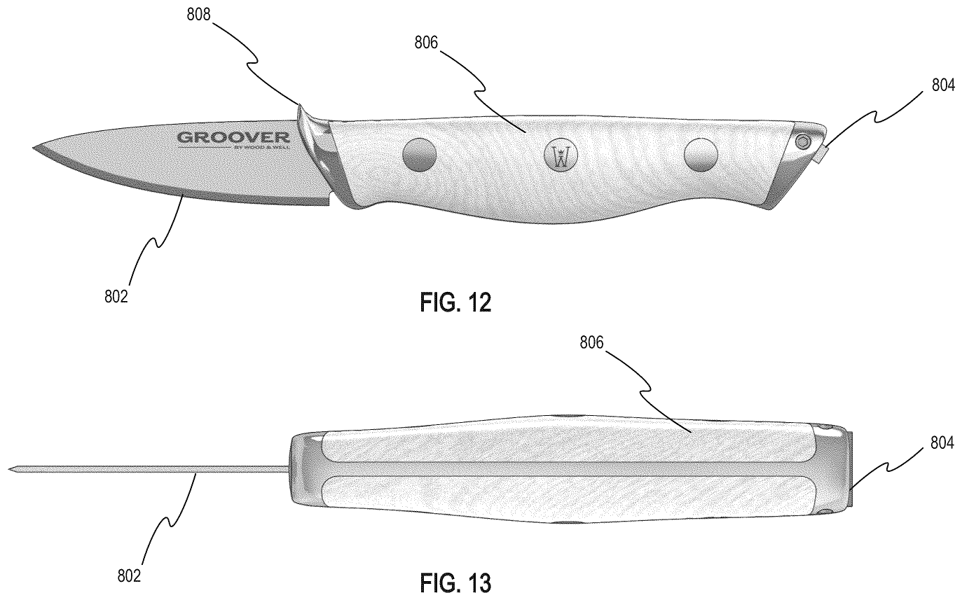

FIG. 10 illustrates a perspective view of the food processing apparatus 800 in a second position, in accordance with an example embodiment. FIG. 11 illustrates a perspective view of the food processing apparatus 800 in a third position, in accordance with an example embodiment. FIG. 12 illustrates a side view of the food processing apparatus 800, in accordance with an example embodiment. FIG. 13 illustrates a side view of the food processing apparatus 800, in accordance with an example embodiment.

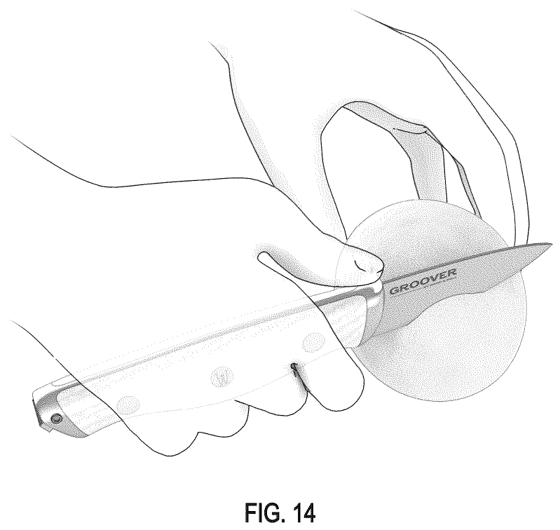

FIG. 14 illustrates the food processing apparatus 800 at a first cutting position in a perspective review. As illustrated in FIG. 14, a lemon is being processed using the food processing apparatus 800. The first blade component 802 can be used to cut directly into food items. Similar to FIG. 7, consistent and clean-cut lemon peels/strips can be produced by applying the second blade component 804 directly against the lemon and sliding the food processing apparatus 800 along the outer skin of the fruit.

While the resulting peels/strips would have clean/even side edges, the beginning and ending (top and bottom) of the peels/strips may appear a little uneven due to angle of the cut and/or the surface of the food/produce. To ensure the peels/strips would have clean/even edges on all four sides, the first blade component 802 or the blunt component 808 (e.g., a blunt dull cutting edge, etc.) may be used to trim the uneven top and bottom edges. Specifically, the food processing apparatus 800 is flipped so that the blunt component 808 is downward facing. By pressing the blunt component 808 directly against the uneven sides/edges of the peels/strips, a straight edge/cut can be formed, resulting in clean/even edges on all sides. In some embodiments, the food processing apparatus 800 may have both the first blade component 802 and the second blade component 804, but not the blunt component 808.

The foregoing example implementation may have various benefits and advantages. For example, example embodiments provide a more precise and customizable approach compared to conventional peelers. Additionally, the U-shaped blades enable consistent and measured cutting of vegetables and fruits, ensuring uniformity and improved presentation. Furthermore, food waste from uneven overcutting can be reduced/minimized.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

What is claimed is:

1. A food processing apparatus, comprising:
a first blade component having a proximal end and a distal end; and
a handle comprises a tang, a bolster, and a butt, wherein the handle is coupled to the first blade component by the proximal end of the first blade component through the bolster.

2. The apparatus of claim 1, wherein the first blade component comprises a cutting edge at the distal end, and a fastening end at the proximal end.

3. The apparatus of claim 2, wherein the cutting edge is configured to face the handle.

4. The apparatus of claim 1, wherein a blunt edge is located on a top side of the bolster.

5. The apparatus of claim 1, wherein the first blade component is U-shaped.

6. The apparatus of claim 1, further comprising:
a second blade component having a proximal end and a distal end, and
wherein the second blade component is configured to couple to the butt by the proximal end of the second blade component,
wherein the distal end of the second blade component comprises a cutting edge, and the proximal end of the second blade component comprises a fastening end.

7. The apparatus of claim 6, wherein the first blade component and the second blade component are U-shaped.

8. The apparatus of claim 7, wherein at least one of the first blade component or the second blade component is trapezoidal or reverse-trapezoidal.

9. The apparatus of claim 6, wherein the second blade component is U-shaped.
